(19) United States
(12) Patent Application Publication
(10) Pub. No.: US 2001/0032569 A1
(43) Pub. Date: Oct. 25, 2001

(54) Carbon black

(76) Inventors: Klaus Bergemann, Kerpen-Sindorf (DE); Egon Fanghanel, Halle/S. (DE); Thomas Luthge, Leuna (DE); Karl Vogel, Alzenau-Michelbach (DE)

Correspondence Address: PILLSBURY WINTHROP LLP, 1600 TYSONS BOULEVARD, MCLEAN, VA, 22102, US

(21) Appl. No.: 09/808,425

(22) Filed: Mar. 15, 2001

(30) Foreign Application Priority Data
Mar. 16, 2000 (DE) 100 12 785.3

(51) Int. Cl. C09C 1/48; C09C 1/56

(52) U.S. Cl. 106/472; 106/476

(57) ABSTRACT

A carbon black with organic groups in which the organic group contains at least one substituted C—C single bond or double bond, and is linked to the black via the two carbon atoms of the C—C single or double bond and wherein at least one carbon atom of the C—C single or double bond contains at least one activating substituent; a method of producing the black of the invention by reacting a carbon black with organic compounds containing a C—C double bond or triple bond, the C—C double bond or triple bond of which is activated by at least one substituent; and fillers, reinforcement fillers, UV stabilizers, conductivity blacks and pigment containing the carbon black.

This application claims priority from German Application No. 100 12 783.5, filed on Mar. 16, 2000, the subject matter of which is hereby incorporated herein by reference.

### BACKGROUND OF THE INVENTION

1. Field of the Invention

The invention relates to a carbon black, a method of production and methods of use.

2. Background Information

EP 0 569 503 teaches a method for the surface modification of carbon-containing material with aromatic groups by electrochemical reduction of a diazonium salt.

It is known that carbon black (“black”) can be provided with organic groups in that the organic groups are linked to the carbon black by a diazonium group produced via the primary amine (WO 96/18688).

The known method has the following disadvantages:

An alkyl group or preferably an aryl group is required as a linking group; the modification therefore always takes place at a rather distant interval from the carbon black surface. A direct screening of the carbon black surface with closely applied polar groups is impossible. The modification does not take place in the immediate vicinity of the surface.

The carbon black is contaminated with acids and/or salts. In addition to the actual modification reagent, predominantly additional acids must be used in order to adjust the pH. These acids are not bound to the carbon black but rather constitute an impurity in the carbon black or must be removed by purification steps.

The non-ionic, organic nitrites that can also be used for diazotization are somewhat poisonous and readily combustible. Groups of the nitrites (counterions, alkyl groups) remain unbound as contaminant in the carbon black.

The use of nitrite in an acidic medium is required to carry out the diazotization. Poisonous nitrogen oxides can develop from this.

The modification by means of diazonium salts takes place primarily in aqueous phase. Due to the high evaporation enthalpy of water, the subsequent necessary drying requires a high expenditure of energy, resulting in substantial expense.

### SUMMARY OF THE INVENTION

It is an object of the present invention to provide a carbon black with organic groups, wherein

the polar groups directly screen the surface,

the modification of the carbon black is sufficiently variable that the groups can be directly over the surface and/or also very far removed from it,

the modification takes place in the direct vicinity of the surface,

the resulting carbon black is not contaminated by acids, salts and the like, so that no purification of the carbon black is required,

the carbon black does not have to be dried with a high expenditure of energy,

no poisonous waste gases are produced during the modification,

no solvents or only slight amounts of solvents that can be readily removed are required, and

the modification is possible without solvents.

Accordingly, the invention provides a carbon black with organic groups wherein the organic group contains at least one substituted C—C single bond or double bond, is linked to the carbon black via the two carbon atoms of the C—C single or double bond and that at least one carbon atom of the C—C single or double bond contains at least one activating substituent.

Activating substituents can be, for example, acceptor substituents. Acceptor substituents can be —COOR, —CO—R, —CN, —SO₂R, —SO₂OR with R═H, alkyl, aryl or functionalized alky or aryl such as, e.g., co-carboxyalkyl, HSO₃—CₓH_{y}—, H₂N—CₓH_{y}—, H₂N—SO₂—CₓH_{y}—.

The carbon black used can be any known black such as, e.g., furnace black, gas black, channel black, flame black, thermal black, acetylene black, plasma black, inversion blacks, known from DE 195 21 565, Si-containing blacks known from WO 98/45361 or DE 19613796, or metal-containing blacks known from WO 98/42778, are blacks and blacks that are the byproducts of chemical production processes. The black can be activated by established reactions. Blacks can be employed that are used as reinforcement filler and rubber mixtures. Colored blacks can be used. Other blacks can be: Conductivity black, black for UV stabilization, black as filler in other systems than rubber such as, e.g., in bitumen, plastic, black as reducing agent in metallurgy.

The primarily applied groups can be further modified by subsequent reactions.

It is a further object of the invention to provide a carbon black with organic groups that is characterized in that it can be obtained by reacting the black with organic compounds containing a C—C double bond or triple bond, the C—C double bond or triple bond of which is activated by at least one substituent.

A further object of the invention is to provide a method of producing the black of the invention, which method is characterized in that black is reacted with organic compounds containing a C—C double bond or triple bond, the C—C double bond or triple bond of which is activated by at least one substituent.

Organic compounds containing a C—C double bond or triple bond that can be used comprise all compounds that carry suitable acceptor substituents for activating the multiple bonds.

The substituents can be tailored to suit the potential areas of application since the reaction principle discovered permits the introduction of hydrophilic as well as lipophilic groups. The groups can also be ionic[ly], polymeric[ally reactive] or reactive for further reactions.

Organic compounds with acceptor substituents can be compounds of formula I in which R¹, R², R³ and R⁴ can be the same or different,

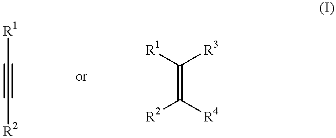

with R¹═—COOR, —CO—R, —CN, ═SO₂R, —SO₂OR,

R², R³, R⁴═R¹, H, alkyl aryl, —COOM with M═H⁺, alkali⁺, alkaline earth⁺⁺, Cl and other non-acceptor substituents and

R═H, alkyl, aryl or functionalized alkyl or aryl such as, e.g., ω carboxyalkyl, HSO₃—CₓH_{y}—, H₂N—CₓH_{y}—, H₂N—SO₂—CₓH_{y}— and similar groups.

Maleic acid and maleic acid imides of the general formula II can be used as organic compounds with acceptor substituents (II)

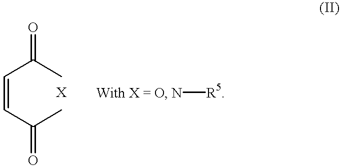

The functional group R⁵ can be alkyl, alkyl functionalized by Y, polymers, cyclic organic groups, aryl, aryl functionalized by Y of the form Ar—Yₙ (n=1-5) with Y═—OH, —SH, —SO₃H, —SO₃M, —B(OH)₂, —O(CH₂—CH₂—O)ₙ—H, —COOH, —COOM, —NH₂, —NR₂, —N((CH₂—CH₂—O)ₙH)₂, CON((CH₂—CH₂—O)ₙH)₂, trialkoxysilyl, perfluoroalkyl, R⁵, —NH₃⁺, —NR₃⁺, —SO₂—NR₂, —NO₂, —Cl, —CO—NR₂, —SS—, —SCN.

The organic group R⁵ on the nitrogen can be:

an aliphatic group, a cyclic, organic group or an organic compound with an aliphatic and a cyclic part,

substituted or unsubstituted, branched or unbranched,

comprised of aliphatic groups, e.g., groups of alkanes, alkenes, alcohols, ethers, aldehydes, ketones, carboxylic acids, hydrocarbons,

cyclic compounds, e.g., alicyclic hydrocarbons such as, e.g., cycloalkyls or cycloalkenyls, heterocyclic compounds such as, e.g. pyrrolidinyl-, pyrrolinyl-, piperidinyl or morpholinyl, aryl groups such as, e.g., phenyl, naphthyl or anthracenyl, and heteroaryl groups such as, e.g., imidazolyl, pyrazolyl, pyridinyl, thienyl, thiazolyl, furyl or indolyl,

substituted by other functional groups,

a chromophoric group or a dye,

suitable unsaturated compounds such as, e.g., p-benzoquinone, ethylvinyl ether or compounds with multiple bonds containing heteroatoms in the multiple bonds such as, e.g., azidodicabenic acid ester.

For compounds according to formula II with X=0 there is the possibility of subsequently functionalizing the products of the type of substituted succinic anhydrides by basic or acidic ring opening, by semi-ester formation with alcohols or alcoholates, as well as by amide formation with amines and by subsequent thermal imidization in the case of primary amines. When ammonia is used, accumulating imides can also be subsequently substituted on the nitrogen.

The organic compound with acceptor substituents can be applied on the black by being mixed in or sprayed on. The organic compound with acceptor substituents can be applied as powder, melt or solution. It is especially advantageous if the organic compound with acceptor substituents is applied during the production of the black, during which the addition of the organic compound takes place at a location exhibiting the necessary temperature.

The reaction for modifying the carbon black can preferably be carried out without solvent or in a solvent, preferably a slightly volatile, organic solvent. The reaction for modifying the carbon black can be carried out at temperatures from 23° C. to 250° C., preferably from 80° C. to 140° C.

The carbon blacks in accordance with the invention and with organic groups can be used, e.g., as filler, reinforcing filler, UV stabilizer, conductivity black or pigment in rubber, plastic, printing inks, inks, inkjet inks, paints and dyes, bitumen, concrete and other construction materials or paper. They can also be used as reducing agent in metallurgy.

The carbon blacks in accordance with the invention have the advantage that

blacks modified in a polar manner (e.g., with —SO₃— groups) can be better dispersed in polar systems, with precedence water,

blacks modified in a non-polar manner (e.g., with alkyl groups) can be better dispersed in non-polar systems such as, e.g., oils,

suitably modified blacks with polar or sterically bulky groups are stabilized electrostatically or sterically in the systems,

blacks modified according to the method of the invention are better-stabilized in dispersions and thus exhibit better coloristic qualities such as color depth and blue cast,

blacks with bound dyes exhibit changed color tones,

blacks with substituents that continue to be reactive can be used for coupling and cross-linking in systems (e.g., rubber),

reactively modified blacks make it possible to bind the black to the polymer,

blacks can be produced that are low in byproducts, salts, acids and moisture.

### DETAILED DESCRIPTION OF THE INVENTION

The blacks used, FW1, Printex 35 and Printex Alpha are products of Degussa AG.

### Example 1

Modification of black in solid phase with maleic acid anhydride

2 g maleic acid anhydride is dissolved in 150 ml acetone, compounded with 10 g black (FW1 or Printex 35) and agitated 30 minutes at room temperature. The solvent is subsequently drawn off in a vacuum and the black tempered five hours in a muffle furnace at 180° C. The resulting black carries carbonic acid anhydride groups.

### Example 2

Modification of black in toluene with maleic acid anhydride

2 g maleic acid anhydride is dissolved in 200 ml toluene and compounded with 10 g black (FW1 or Printex 35). The suspension is boiled 4 to 16 hours under reflux and then drawn off, washed with toluene and dried eight hours in a drying oven at 105° C. The resulting black carries carbonic acid anhydride groups.

### Example 3

Basic ring opening reaction and neutralization in black modified with maleic acid anhydride for the production of carboxylate groups

10 g of a black modified in accordance with Example 1 or Example 2 (FW 1 or Printex 35) is agitated two hours in 100 ml 1N KOH solution. The KOH solution is then drawn off and the filter residue washed with water until the pH is in the neutral range (pH≈6-7). The modified black is subsequently dried eight hours at 100° C. The resulting black carries carboxylate groups.

### Example 4

Reaction with maleic acid and subsequent neutralization

2 g maleic acid is dissolved in 100 ml water. 10 g black (FW1 or Printex 35) is added to the solution and the suspension boiled two hours under reflux, then drawn off, the filter residue washed with 100 ml water and subsequently agitated two hours in 100 ml 1N KOH solution. The black is drawn off and washed with water until the pH is in the neutral range. The matter is subsequently dried eight hours at 100° C. The resulting black carries carboxylate groups.

### Example 5

Reaction with monopotassium salt of acetylene dicarboxylic acid

2 g of monopotassium salt of acetylene dicarboxylic acid is dissolved in 150 ml water and 10 g black (FW1 or Printex 350 added to the solution. The suspension is boiled one hour under reflux and subsequently drawn off. The modified black is then washed with 200 ml water and dried eight hours at 100° C. The resulting black carries carboxyl groups and carboxylate groups.

### Example 6

Reaction with fumaric acid

2 g fumaric acid is suspended in 150 ml acetone. 10 g black (FW1 or Printex 35) are added to the suspension and the suspension boiled two hours under reflux. The solvent is then distilled off in a vacuum and the mixture heated 48 hours to 120° C. The resulting black carries carboxylate groups.

### Example 7

Modification of black with the sodium salt of N-(4-sulfonatophenyl) maleic acid imide in solid phase

2 g of the sodium salt of N-(4-sulfonatophenyl) maleic acid imide are dissolved in 150 ml water and compounded with 10 g black (FW1). The water is distilled in a vacuum. The mixture is then heated 5 hours to 180° C. The modified black is then washed with 200 ml water and subsequently dried eight hours at 100° C. The resulting black carries sodium sulfonate groups.

### Example 8

Modification of black with the sodium salt of N-(4-sulfonatophenyl) maleic acid imide in water

2 g N-(4-sulfonatophenyl) maleic acid imide is dissolved in 100 ml water, compounded with 10 g black (FW 1) and heated 4 hours on the reflux. The matter [modified black] is drawn off, washed with water and dried eight hours in a drying oven at 105° C. The resulting black carries sodium sulfonate groups.

### Example 9

Modification of black with N-(4-sulfamoyl-phenyl) maleic acid amide in solid phase

5 g N-(4-sulfamoyl-phenyl) maleic acid amide is dissolved in 250 ml acetone, compounded with 25 g black (FW 1 or Printex 35) and agitated 30 minutes at room temperature. The solvent is subsequently drawn off in a vacuum and the black tempered five hours in a muffle furnace at 180° C. The resulting black carries sulfonamide groups.

### Example 10

Modification of black with N-dodecylmaleic acid amide

2 g maleic acid amide N-dodecylmaleic acid amide are dissolved in 150 ml toluene and compounded with 10 g black (FW 1 or Printex Alpha). The suspension is boiled four hours under reflux and then drawn off, washed with acetone and dried eight hours in a drying oven at 105° C.

The resulting black carries dodecyl groups.

### Example 11

Qualities of the modified blacks (FW 1 or Printex 35) in paint systems containing solvent

The specimens are ground in a polar 2K system containing solvent, namely, the Synthanal LS 768 system, that is subsequently cross-linked with Desmodur N 75.

TABLE 1

| Component | % |
|---|---|
| Synthalan LS 768 | 68 |
| Butylacetate 98% | 22.9 |
| FW1/Printex 35 | 9.1 |

The paint is applied with a Desmodur N 75 and Synthalan LS 768. The concentration of black in the coat is 5% relative to “solid binder”.

Dispersing conditions

The dispersing is carried out in 2 steps:

| | | |
|---|---|---|
| 1. | Laboratory dissolver: | |
| | Dispersing time: | 5 mm, 4000 rev. min⁻¹ |
| | Disk diameter: | 40 mm |
| | Circumferential speed: | 8.37 m/sec |
| 2. | Skandex dispenser BA-S20: | |
| | Dispersing time: | 60 mm |
| | Grinding bodies: | 550 g steel balls Ø 2 mm |
| | Cooling: | Stage 2 |

Viscosity behavior

The viscosity is tested with a rotational viscometer from the Haake company. The flow curve is recorded thereby.

Results of the testing of Printex 35 modified with maleic acid anhydride using application technology in a paint system containing solvent are shown in table 2.

TABLE 2

| Specimen | My | dM | η (100 s-1) |
|---|---|---|---|
| Printex 35 elementary [original] | 228 | −3.5 | 900 mPas |
| black | | | |
| Printex 35 modified according to | 229 | 2.0 | 800 mPas |
| examples 1 and 3 | | | |

The modified black has a bluer shade and displays reduced viscosity.

Results of the testing of FW 1 modified with sulfonamide groups using application technology in a paint system containing solvent are shown in table 3.

TABLE 3

| Specimen | My 5% | dM 5% |
|---|---|---|
| FW1 elementary [original] black | 277 | −1.4 |
| FW 1 modified according to | 293 | 12 |
| example 9 with SO₂NH₂ groups | | |

The modified black clearly has a deeper color and a significantly bluer shade.

### Example 12

Qualities of the modified blacks in hydrous systems

The pigment blacks are dispersed in aqueous systems I (table 4) and II (table 5) containing wetting agent and free of binding agent.

TABLE 4
Paint system I:

| Component | % |
|---|---|
| Water | 55 |
| Tegofoamex 830 | 0.30 |
| AMP 90 | 0.60 |
| Tego Dispers 750 W 40% | 24.9 |
| Pigment blacks | 13 |

TABLE 5

| | |
|---|---|
| Component | G |

Paint system II: Mother [parent, stock] paint A

| | |
|---|---|
| Tegofoamex 830 | 1.3 |
| Tego Dispers 750 W 40% | 175.4 |

Grinding material recipe Printex 35/SS4

| | |
|---|---|
| Mother paint A | 64.2 |
| AMP 90 | 0.49 |
| Pigment black | 9.5 |

The paint is applied with Alberdingk U 710 30%. The concentration of black relative to binding agent (solid) is fixed at 10%.

Dispersing conditions

The dispersing is carried out in 2 steps:

| | | |
|---|---|---|
| 1. | Laboratory dissolver: | |
| | Dispersing time: | 5 mm, 4000 rev. min⁻¹ |
| | Disk diameter: | 40 mm |
| | Circumferential speed: | 8.37 m/sec |
| 2. | Skandex dispenser BA-S20: | |
| | Dispersing time: | 60 min |
| | Grinding bodies: | 275 g chromanite steel beads |
| | | Ø 2 mm |
| | Cooling: | Stage 2 |

Results of the testing of Printex 35 modified with maleic acid anhydride using application technology in hydrous paint system I are shown in table 6.

TABLE 6

| Specimen | My 10% | dM 10% |
|---|---|---|
| Printex 35 elementary [original] | 237 | 1.9 |
| black | | |
| Printex 35 modified according to | 241 | 3.8 |
| examples 1 and 3 | | |

The modified product has a deeper color and a bluer shade.

Results of the testing of Printex 35 modified with sulfanilamide using application technology in hydrous paint system II containing solvent are shown in table 6.

TABLE 7

| Specimen | My 10% | dM 10% |
|---|---|---|
| Printex 35 elementary [original] | 222 | 1.1 |
| black | | |
| Printex 35 modified according to | 230 | 5 |
| example 9 | | |

The functionalized specimen has a deeper color and a bluer shade.

The system components of the paint systems used in examples 11 and 12 are products of the following companies:

| | |
|---|---|
| Alberdink U 710 30 % | Alberdink Boley |
| Tegofoamex 830 | Tego Chemie Service GmbH |
| Tego Dispers 750 W 40% | Tego Chemie Service GmbH |
| AMP 90 | Merk KgaG |
| Desmodur N 75 | Bayer AG |
| Synthalan LS 768 | Synthopol Chemie |

The My values cited in the examples are determined according to DIN 55979. The dM value is determined as follows:

The values X, Y and Z are determined according to DIN 6174. The color-tone-independent black number My can be determined from these values according to the formula 100 log(Yn/Y)=My. In a similar manner the color-tone-dependent black number Mc is calculated according to the formula 100 (log(Yn/Y)+log(Xn/X)−log(Zn/Z)=Mc. The color-tone part [contribution] dM is calculated according to dM=Mc−My=100 (log(Xn/X)−log(Zn/Z)). The greater the dM value, the bluer the shade of the carbon black; the smaller the dM value, the browner the shade of the carbon black.

### Example 13

Qualities of the blacks modified according to example 10 with dodecyl groups as regards their water adsorption

The black specimens are dried overnight at 120° C., cooled off in an desiccator over silica gel in a vacuum and then weighed in small open glass dishes. The blacks are then stored in the desiccator at room temperature over a concentrated sodium chloride solution (rel. air humidity approximately 85%) and tared [weighed out] at fixed time intervals.

The water adsorption is calculated from the relative increase in weight of the black specimens and is entered in the following as a function of the storage time at 85% air humidity (table 8).

TABLE 8
Increase in weight of the black specimens due to water adsorption in
% by mass as a function of the residence time in a moist atmosphere
in hours

| | Water adsorption in % by mass relative to the | | | |
|---|---|---|---|---|
| | amount of black | | | |
| Residence time in | | FW1 alkylated | | Printex Alpha |
| moist atmosphere | | according to | Printex | alkylated according |
| in hours | FW 1 | example 10 | Alpha | to example 10 |
| 0.0 | 0.0 | 0.0 | 0.0 | 0.0 |
| 29.0 | 5.4 | 2.8 | 1.7 | 0.8 |
| 43.0 | 5.5 | 3.2 | 2.0 | 0.9 |
| 66.5 | 5.6 | 3.4 | 2.1 | 1.0 |
| 89.5 | 5.6 | 3.5 | 2.2 | 1.0 |
| 164.5 | 5.7 | 3.7 | 2.3 | 1.0 |
| 189.5 | 5.7 | 3.7 | 2.3 | 1.0 |

The modification causes a reduction of the water absorption, that is particularly advantageous for applications with plastic. The water absorption of the FW1 and Printex Alpha modified according to example 10 with C₁₂H₂₅ groups is 2.0 and 1.3 percent by weight lower for the entire test than in the case of the particular reference black.

### Example 14

Dispersion of modified black in water

15% by mass FW1 per 100 parts water with 45% by mass (relative to the black) Hydropalat 3065 are dispersed in a stable manner in a standard dispersion. To this end, a dispersion is first carried out for 30 min at 5000 rpm with an Ultra Turrax and a subsequent dispersion for 60 minutes with ultrasound.

However, 15% by mass FW1, that is functionalized according to example 8 with sulfonate groups, per 100 parts water is already dispersed in a stable manner with only 13% Hydropalat 3065 according to the above method.

Thus, the functionalizing of the black results in an improvement of the dispersing qualities in aqueous applications.

Hydropalat 3065 is a product of Henkel KgaA Dusseldorf.

What is claimed is:

1. A carbon black with organic groups, wherein the organic group contains at least one substituted C—C single bond or double bond, is linked to the carbon black via the two carbon atoms of the C—C single or double bond and wherein at least one carbon atom of the C—C single or double bond contains at least one activating substituent.

2. The carbon black according to claim 1, wherein the activating substituent is an acceptor substituent.

3. A carbon black with organic groups that is obtained by reacting a carbon black with organic compounds containing a C—C double bond or triple bond, the C—C double bond or triple bond of which is activated by at least one substituent.

4. A method of producing the carbon black according to claim 1, wherein a carbon black is reacted with organic compounds containing a C—C double bond or triple bond, the C—C double bond or triple bond of which is activated by at least one substituent.

5. The method according to claim 4, wherein the modification is carried out in a solvent.

6. The method according to claim 4, wherein the modification is carried out without solvent.

7. A filler, reinforcing filler, UV stabilizer, conductivity black or pigment in rubber, plastic, printing inks, inks, inkjet inks, paints and dyes, bitumen, concrete and other construction materials or paper comprising the carbon black according to claim 1.
